(19) United States
(12) Patent Application Publication
(10) Pub. No.: US 2024/0397546 A1
(43) Pub. Date: Nov. 28, 2024

(54) METHOD FOR WIRELESS COMMUNICATION, AND DEVICE

(71) Applicant: GUANGDONG OPPO MOBILE TELECOMMUNICATIONS CORP., LTD., Dongguan (CN)

(72) Inventors: Yanan LIN, Dongguan (CN); Jing XU, Dongguan (CN); Yi ZHANG, Dongguan (CN)

(21) Appl. No.: 18/795,064

(22) Filed: Aug. 5, 2024

Related U.S. Application Data
(63) Continuation of application No. PCT/CN2022/106794, filed on Jul. 20, 2022.

(30) Foreign Application Priority Data
Feb. 18, 2022 (CN) 202210152339.8

(51) Int. Cl. H04W 72/566; H04L 1/1812; H04W 72/1268; H04W 92/18

(52) U.S. Cl. CPC H04W 72/566; H04L 1/1812; H04W 72/1268; H04W 92/18

(57) ABSTRACT

Provided is a method for wireless communication. The method includes: in a case that a first channel carries first information and second information, determining a priority of the first channel as a second priority or performing a corresponding operation where a priority of the first channel is considered as a second priority, wherein a priority of the first information is a first priority, a priority of the second information is the second priority, and a predefined priority of the first channel is the first priority, wherein the first channel is overlapped with a second channel configured to transmit the second information, and the second priority is higher than the first priority.

### CROSS-REFERENCE TO RELATED APPLICATION

This application is a continuation of International Application No. PCT/CN2022/106794, filed Jul. 20, 2022, which claims priority to Chinese Patent Application No. 202210152339.8, filed on Feb. 18, 2022, the entire disclosures of which are incorporated herein by reference.

### TECHNICAL FIELD

Embodiments of present disclosure relate to the technical field of communications, and in particular, relate to a method and apparatus for wireless communication, and a device, a storage medium and a program product thereof.

### RELATED ARTS

In a 5G new radio (NR) system, multiplexing of information of different priorities in the same channel for transmission is supported, and further research is needed on this transmission scenario.

### SUMMARY

The embodiments of the present disclosure provide a method and apparatus for wireless communication, and a device, a storage medium and a program product thereof. The technical solutions are as follows.

According to some embodiments of the present disclosure, a method for wireless communication is provided. The method includes:

in a case that a first channel carries first information and second information, determining a priority of the first channel as a second priority or performing a corresponding operation where the priority of the first channel is considered as the second priority, wherein a priority of the first information is a first priority, a priority of the second information is the second priority, and a predefined priority of the first channel is the first priority, wherein the first channel is overlapped with a second channel configured to transmit the second information, and the second priority is higher than the first priority.

According to some embodiments of the present disclosure, a communication device is provided. The communication device includes a processor and a memory storing at least one computer program, wherein the processor, when loading and running the at least one computer program, is caused to perform the method for wireless communication as described above.

### BRIEF DESCRIPTION OF DRAWINGS

FIG. 1 is a schematic diagram of a network architecture according to some embodiments of the present disclosure;

FIG. 2 is a flowchart of a method for wireless communication according to some embodiments of the present disclosure;

FIG. 3 is a flowchart of a method for wireless communication according to some embodiments of the present disclosure;

FIG. 4 is a block diagram of an apparatus for wireless communication according to some embodiments of the present disclosure;

FIG. 5 is a schematic structural diagram of a terminal device according to some embodiments of the present disclosure; and

FIG. 6 is a schematic structural diagram of a network device according to some embodiments of the present disclosure.

### DETAILED DESCRIPTION

For clearer descriptions of the objects, technical solutions, and advantages of the present disclosure, the embodiments of the present disclosure are further described in detail below with reference to the accompanying drawings.

A network architecture and a service scenario described in the embodiments of the present disclosure are intended to describe the technical solutions according to the embodiments of the present disclosure more clearly, but do not constitute any limitation on the technical solutions according to the embodiments of the present disclosure. Those of ordinary skill in the art may understand that with the evolution of the network architecture and the appearance of new service scenarios, the technical solutions according to the embodiments of the present disclosure are also applicable to similar technical problems.

The technical solutions according to the embodiments of the present disclosure are applicable to various communication systems, for example, a global system of mobile communication (GSM), a code division multiple access (CDMA) system, a wideband code division multiple access (WCDMA) system, a general packet radio service (GPRS) system, a long-term evolution (LTE) system, an advanced long-term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN) system, a wireless fidelity (Wi-Fi) system, a 5th generation (5G) system, or other communication systems.

Generally, a conventional communication system supports a limited number of connections and is easy to implement. However, with the development of communication technologies, a mobile communication system supports not only the traditional communications, but also other communications, such as device-to-device (D2D) communications, machine-to-machine (M2M) communications, machine type communications (MTC), vehicle-to-vehicle (V2V) communications, vehicle-to-everything (V2X) communications, and the like. The embodiments of the present disclosure also are applicable to these communication systems.

The communication system in the embodiments of the present disclosure is applicable to a carrier aggregation (CA) scenario, a dual connectivity (DC) scenario, and a standalone (SA) networking scenario.

The communication system in the embodiments of the present disclosure is applicable to an unlicensed spectrum, and the unlicensed spectrum may also be construed as a shared spectrum. Alternatively, the communication system in the embodiments of the present disclosure is applicable to a licensed spectrum, and the licensed spectrum may also be construed as a non-shared spectrum.

The communication system in the embodiments of the present disclosure is applicable to an existing frequency band, and is also applicable to a frequency band to be put in to use in the future.

The embodiments of the present disclosure are applicable to the NTN system and a terrestrial network (TN) system.

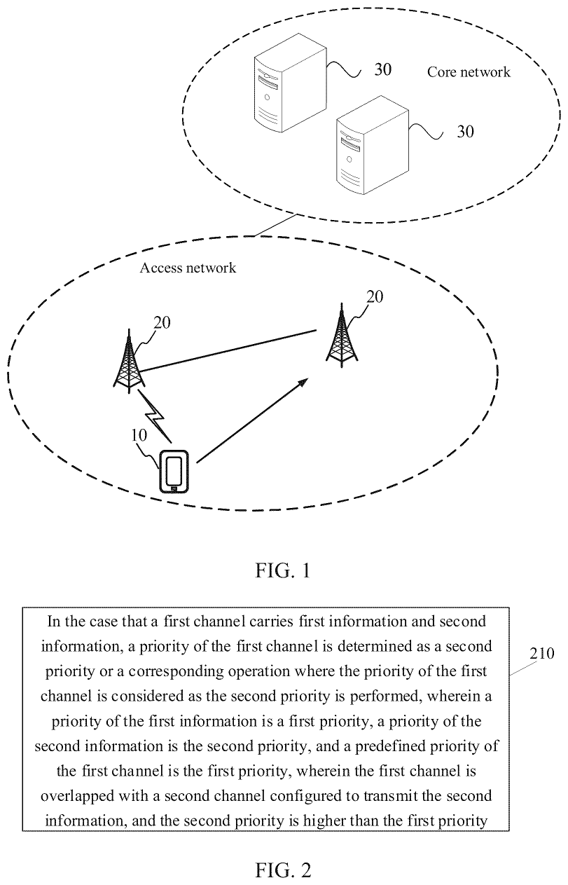

FIG. 1 shows a schematic diagram of a network architecture according to some embodiments of the present disclosure. The network architecture includes a terminal device 10, an access network device 20, and a core network element 30.

The terminal device 10 refers to a user equipment (UE), an access terminal, a subscriber unit, a user station, a mobile station, a mobile table, a remote station, a remote terminal, a mobile device, a wireless communication device, a user proxy, or a user device. In some embodiments, the terminal device 10 is a cellular phone, a cordless phone, a Session Initiation Protocol (SIP) phone, a wireless local loop (WLL) station, a personal digital assistant (PDA), a handheld device with a wireless communication function, a computing device or other processing devices connected to a wireless modem, an in-vehicle device, a wearable device, a terminal device in the 5G system, a terminal device in an evolved public land mobile network (PLMN), or the like, which is not limited in the embodiments of the present disclosure. For the convenience of description, the above devices are collectively referred to as the terminal device. Generally, a plurality of terminal device 10 are deployed, and one or more terminal devices 10 are distributed in a cell managed by each access network device 20. In the embodiments of the present disclosure, the “terminal device” and the “UE” generally have the same meaning and are interchangeable, and those skilled in the art can understand the meanings.

The access network device 20 is a device deployed in the access network and is configured to provide a wireless communication function for the terminal device 10. The access network device 20 includes various forms of macro base stations, micro base stations, relay stations, access points, and the like. In systems adopting different wireless access technologies, the devices having the functions of the access network device may have different names, for example, a gNodeB or a gNB in a 5G NR system. With the evolution of the communication technologies, the name of the “access network device” may change. For the convenience of description, in the embodiments of the present disclosure, the above devices providing the wireless communication function for the terminal device 10 are collectively referred to as the access network device. In some embodiments, a communication relationship is established between the terminal device 10 and the core network element 30 over the access network device 20. Illustratively, in the LTE system, the access network device 20 is an evolved universal terrestrial radio access network (EUTRAN) or one or more eNodeBs in the EUTRAN; and in the 5G NR system, the access network device 20 is a radio access network (RAN) or one or more gNBs in the RAN. In the embodiments of the present disclosure, the “network device” refers to the access network device 20, such as a base station, unless otherwise specified.

The core network element 30 is a device deployed in the core network. The core network element 30 mainly functions to provide user connection, user management, and service bearing, and to provide an interface to an external network as a bearer network. For example, the core network device in the 5G NR system includes devices such as an access and mobility management function (AMF) entity, a user plane function (UPF) entity, and a session management function (SMF) entity, and other devices.

In some embodiments, the access network device 20 communicates with the core network element 30 using an air interface technology, such as an NG interface in the 5G NR system. The access network device 20 communicates with the terminal device 10 using a radio technology, such as a Uu interface.

The “5G NR system” in the embodiments of the present disclosure is also referred to as a 5G system or an NR system, and those skilled in the art can understand the meanings. The technical solutions according to the embodiments of the present disclosure are applicable to the LTE system, the 5G NR system, a subsequent evolution system of the 5G NR system, and other communication systems such as a narrow band Internet of things (NB-IoT) system, which is not limited in the present disclosure.

In the embodiments of the present disclosure, the network device provides services for cells, and the terminal device communicates with the network device over the transmission resources (such as frequency domain resources or frequency spectrum resources) on carriers used by the cells. The cell may be a cell corresponding to the network device (for example, a base station), and the cell may belong to a macro base station or a base station corresponding to a small cell. The small cell includes a metro cell, a micro cell, a pico cell, a femto cell, or the like. The small cells have the characteristics of small coverage and low transmission power, and are applicable to providing high rate data transmission services.

It should be understood that the term “indication” mentioned in embodiments of the present disclosure may be a direct indication, an indirect indication, or an indication that there is an association relationship. For example, that A indicates B may mean that A indicates B directly, e.g., B may be acquired by A; or that A indicates B indirectly, e.g., A indicates C, and B may be acquired by C; or that there is an association relationship between A and B.

In the descriptions of the embodiments of the present disclosure, the term “corresponding” may refer to a direct or indirect correspondence between two items, or may refer to an association relationship between two items, or may refer to a relationship of indicating and being indicated, or configuring and being configured.

In the embodiments of the present disclosure, the term “configuration” may include configuration over at least one of system information, radio resource control (RRC) signaling, or a media access control control element (MAC CE).

In some embodiments of the present disclosure, the term “protocol” may refer to a standard protocol in the field of communication, and for example, may include an LTE protocol, an NR protocol, and a related protocol applicable to a future communication system, which is not limited in the present disclosure.

Some background technical knowledge involved in the present disclosure is introduced prior to the introduction of the technical solutions of the present disclosure. The following relevant technologies as optional solutions may be arbitrarily combined with the technical solutions according to the embodiments of the present disclosure, and the combined solutions all fall within the protection scope of the embodiments of the present disclosure. The embodiments of the present disclosure include at least part of the following.

NR Rel-15 stipulates that overlapped multiple physical uplink control channels (PUCCHs) or PUCCHs and physical uplink shared channels (PUSCHs) can be multiplexed in a single channel for transmission only when they need to satisfy a multiplexing timing relationship (see clause 9.2.5 of TS 38.213 for the definition of multiplexing timing). Otherwise, the terminal device will judge the situation as abnormal. The timing relationship here is mainly to ensure that the terminal device has enough time to judge whether the information carried over different uplink channels needs to be multiplexed or not, and the time required for uplink control information (UCI) cascading, coding, or the like during multiplexing transmission.

In NR Rel-16, in order to better support ultra-reliable low latency (URLLC) services, the physical channel may be configured with a 2-level priority, i.e., high priority (priority index 1) or low priority (priority index 0). Generally, URLLC services are transmitted over the high-priority channel. In the case that multiple uplink channels with different priorities overlap, for a low-priority channel, the terminal device adopts the Rel-15 working mechanism to determine the multiplexed channel. In the case that a high-priority uplink channel is overlapped with a low-priority channel (multiplexed or non-multiplexed channel), the transmission over the low-priority channel is canceled, and only the transmission over the high-priority channel is enabled. In the case that multiple high-priority channels overlap, the Rel-15 working mechanism is adopted to determine the multiplexed channel. In such processing mechanisms, the transmission efficiency of the low-priority channels is sacrificed to ensure the reliability and latency requirements of the high-priority channels. In some embodiments, the priority of the uplink channel is determined by:
Higher layer signaling configuration, for example, a PUCCH carrying a scheduling request (SR), and a PUCCH carrying a semi-persistent scheduling (SPS) hybrid automatic repeat request-acknowledgement (HARQ-ACK).
For an uplink channel (e.g., a PUCCH or a PUSCH) that is indicated or scheduled by downlink control information (DCI), in the case that the DCI includes a priority indicator field, the priority of the corresponding uplink channel is indicated by the DCI.
In the case that no priority is configured, the priority of the corresponding uplink channel is a low priority by default (the priority index is 0).

NR Rel-17 is designed to minimize the impact of the transmission over the high-priority channel on the transmission over the low-priority channel, and therefore, it is proposed to support the multiplexing of information of different priorities for transmission in a single uplink channel. However, in the progress of the current discussion, multiplexing transmission of information of different priorities is not applicable to all uplink control information, and specific supported multiplexing transmission combinations include:
Low-priority HARQ-ACK is multiplexed in a high-priority PUSCH;
High-priority HARQ-ACK is multiplexed in a low-priority PUSCH;
Low-priority HARQ-ACK, high-priority HARQ-ACK, and/or channel state information (CSI) are multiplexed in a high-priority PUSCH;
High-priority HARQ-ACK, low-priority HARQ-ACK and/or CSI are multiplexed in a low-priority PUSCH.

For terminal devices supporting multiplexing transmission of information of different priorities, such as a PUSCH preconfigured with a low priority carrying high-priority UCI, or a PUCCH carrying high-priority UCI and low-priority UCI, the priority information of this uplink channel needs to be explicitly defined, or else it will affect other processings. If this uplink channel is processed according to the low priority, it will cause a performance loss of the high-priority UCI. In some embodiments, the performance loss mentioned herein may include the following.
1. Power loss
The UE allocates power to PUSCH/PUCCH/physical random access channel (PRACH)/sounding reference signal (SRS) transmissions according to the following priority order (in descending order):
   PRACH transmission on the primary cell (PCell);
   PUCCH or PUSCH transmissions with higher priority index according to clause 9;
   For PUCCH or PUSCH transmissions with same priority index;
   PUCCH transmission with HARQ-ACK information, and/or SR, and/or link recovery request (LRR), or PUSCH transmission with HARQ-ACK information;
   PUCCH transmission with CSI or PUSCH transmission with CSI;
   PUSCH transmission without HARQ-ACK information or CSI and, for Type-2 random access procedure, PUSCH transmission on the PCell; and
   SRS transmission, with aperiodic SRS having higher priority than semi-persistent and/or periodic SRS, or PRACH transmission on a serving cell other than the PCell.
2. Canceled Transmission
A UE that detects a DCI format 2_4 for a serving cell cancels a PUSCH transmission or an actual repetition of a PUSCH transmission [6, TS 38.214] if the PUSCH transmission is with repetition Type B, as determined in clauses 9 and 9.2.5 or in clause 6.1 of [6, TS 38.214], or an SRS transmission on the serving cell if, respectively,
   the transmission is PUSCH with priority 0, if the UE is provided with uplinkCancellationPriority.
3. Transmission is canceled in the case of handling of a collosion between slidelink (SL) HARQ-ACK feedback and the PUCCH carrying downlink HARQ-ACK.
For prioritization between SL HARQ-ACK information in a first PUCCH and DL HARQ-ACK or SR or CSI in a second PUCCH:
   if the second PUCCH has priority index 1,
      if sl-PriorityThreshold-UL-URLLC is provided,
      the UE transmits the first PUCCH if a smallest priority value of the first PUCCH is smaller than sl-PriorityThreshold-UL-URLLC; otherwise, the UE transmits the second PUCCH;
   else,
      the UE transmits the second PUCCH;
   else,
      the UE transmits the first PUCCH if the smallest priority value of the first PUCCH is smaller than sl-PriorityThreshold; otherwise, the UE transmits the second PUCCH.
4. Additional standardization work is required in the case of handling of a collision between SL HARQ-ACK feedback and PUSCH.

When a UE determines overlapping for PUCCH transmissions with SL HARQ-ACK reports and PUSCH of smaller priority index, including repetitions if any, after resolving the overlapping PUCCH other than PUCCH transmissions with SL HARQ-ACK reports and/or PUSCH transmissions, if the PUSCH includes no UCI, the UE resolves the overlapping for PUCCH transmissions with SL HARQ-ACK reports and PUSCH of smaller priority index as described in clauses 9.2.5 and 9.2.6.

When a UE determines overlapping for PUCCH transmissions with SL HARQ-ACK reports and PUSCH of larger priority index only, including repetitions if any, after resolving the overlapping PUCCH other than PUCCH transmissions with SL HARQ-ACK reports and/or PUSCH transmissions, the UE does not transmit the PUCCH with SL HARQ-ACK reports.

FIG. 2 is a flowchart of a method for wireless communication according to some embodiments of the present disclosure. Referring to FIG. 2, the method is applicable to the communication system shown in FIG. 1, and the method may include the following processes.

In process 210, in the case that a first channel carries first information and second information, a priority of the first channel is determined as a second priority or a corresponding operation where the priority of the first channel is considered as the second priority is performed. A priority of the first information is a first priority, a priority of the second information is the second priority, and a predefined priority of the first channel is the first priority, wherein the first channel is overlapped with a second channel configured to transmit the second information, and the second priority is higher than the first priority.

The predefined priority of the first channel is the first priority, and the first channel is configured to carry the first information of the first priority. In the case that the second information of the second priority is multiplexed for transmission in the first channel, the priority of the first channel is the second priority. For example, the priority of the first channel is considered as the second priority, or the priority of the first channel is determined as the second priority, or the priority of the first channel is defined as the second priority. That is, the priority of the first channel is changed from the predefined first priority to the second priority. In some embodiments, in the case that the first channel carries the first information and the second information, the priority of the first channel is determined as the second priority. In some embodiments, in the case that the first channel carries the first information and the second information, the corresponding operation where the priority of the first channel is considered as the second priority is performed.

In some embodiments, the first channel and the second channel are both uplink channels. In some embodiments, the first channel is a PUSCH or a PUCCH. For example, the first channel is a PUSCH, and the second channel is a PUCCH. For example, the first channel is a PUSCH dynamically scheduled by DCI or a PUSCH configured by higher layer signaling. For another example, the first channel and the second channel are both PUCCHs. For example, the first channel is a PUCCH, the second channel is a PUCCH, and the first and second PUCCHs are two different PUCCHs.

In some embodiments, the physical channel may be configured with a 2-level priority, including a high priority and a low priority. The above second priority may also be referred to as the high priority and the first priority may also be referred to as the low priority. The priority value may be represented by a priority index, for example, the priority index corresponding to the second priority (high priority) is 1, i.e., the second priority (high priority) corresponds to priority index 1; and the priority index corresponding to the first priority (low priority) is 0, i.e., the first priority (low priority) corresponds to priority index 0. Certainly, it is only an example that the larger the priority index is, the higher the priority is. In some other possible implementations, it may also be specified that the smaller the priority index is, the higher the priority is, which is nt limited in present disclosure.

In some embodiments, the predefined priority of the first channel is the first priority, which includes, but it not limited to, any of the following scenarios:

Case 1: the first channel is configured to transmit the first information.

Since the priority of the first information is the first priority, in the case that the first channel is configured to transmit the first information, the predefined priority of the first channel may be considered as the first priority. For example, the first information is information of the first priority (low priority), and if the first channel is configured to transmit the first information, the predefined priority of the first channel is the first priority (low priority).

Case 2: configuration information indicates that the predefined priority of the first channel is the first priority.

In some embodiments, a terminal device receives configuration information from a network device. The configuration information indicates that the predefined priority of the first channel is the first priority. In some embodiments, the configuration information is higher layer signaling or DCI. Exemplarily, in the case that the configuration information is the higher layer signaling, the higher layer signaling may be a PUCCH carrying an SR, a PUCCH carrying an SPS HARQ-ACK, or the like. Exemplarily, in the case that the configuration information is DCI, the DCI may include a priority indicator field, which indicates that the predefined priority of the first channel is the first priority. For example, in the case that the first channel is an uplink channel (PUCCH or PUSCH) indicated or scheduled by DCI, and the DCI includes the priority indicator field, the predefined priority of the first channel is indicated by the DCI. For example, the priority indicator field in the DCI carries a priority index 0, indicating that the predefined priority of the first channel is the first priority (low priority).

Case 3: the protocol stipulates that the predefined priority of the first channel is the first priority.

In some embodiments, the predefined priority for the first channel is determined as the first priority in accordance with the rules of the protocol. For example, the protocol stipulates that, for an uplink channel, in the case that the priority of the uplink channel is not configured, the priority of the uplink channel is defaulted as (or considered as) the first priority (low priority). Then, in the case that the priority of the first channel is not configured, the predefined priority of the first channel is the first priority (low priority) according to the above stipulation in the protocol.

In some embodiments, the second channel is not transmitted. The second channel was originally configured to transmit the second information, but since the second information is multiplexed for transmission in the first channel, the second channel may not be transmitted in order to avoid a waste of transmission resources.

In some embodiments, the first channel is overlapped with the second channel, which includes a scenario where the first channel is overlapped with the second channel in time domain. For example, in the case that the first channel is overlapped with the second channel in the time domain, it may be considered that the first channel is overlapped with the second channel. In some embodiments, in the case that the first channel is overlapped with the second channel, the first channel and the second channel may also overlap in a frequency domain, in addition to that the first channel is overlapped with the second channel in the time domain.

In some embodiments, the first channel carries the first information and the second information, which includes: the first information is transmitted over the first channel upon being processed based on a configuration parameter of the first priority; and/or, the second information is transmitted over the first channel upon being processed based on a configuration parameter of the second priority. In some embodiments, the processing described above includes, but is not limited to, at least one of: encoding, rate matching, or resource mapping. During content preparation for the first channel (e.g., signal processing, data preparation, baseband processing, etc.), information of the low priority (i.e., the first information) is processed based on a configuration parameter of the low priority, and information of the high priority (i.e., the second information) is processed based on a configuration parameter of the high priority. However, when the first channel needs to be compared with other channels/signals in terms of priority, this first channel is considered to have the high priority. Furthermore, different priorities may correspond to different configuration parameters, the above configuration parameters of the first priority are configuration parameters corresponding to the first priority, and the configuration parameters of the second priority are configuration parameters corresponding to the second priority. The above configuration parameters may be configuration parameters related to at least one of encoding, rate matching, or resource mapping. For example, the first priority and the second priority correspond to different encoding rates.

In some embodiments, the priority of the first channel is the second priority in the case of handling transmission power reduction. That is, in the case of handling transmission power reduction, the priority of the first channel is determined as the second priority (high priority), or a corresponding operation where the priority of the first channel is considered as the second priority (high priority) is performed. For example, the transmission power of a channel of a low priority is preferentially reduced, and the transmission power of a channel of a high priority is not reduced or is reduced selectively later.

In some embodiments, the priority of the first channel is the second priority in the case of handling a collision with a SL channel. That is, in the case of handling a collision with a SL channel, the priority of the first channel is determined as the second priority (high priority), or a corresponding operation where the priority of the first channel is considered as the second priority (high priority) is performed. In some embodiments, the SL channel is configured to transmit SL HARQ feedback information. For example, in the case that the first channel collides with the SL channel, in the case that the priority of the first channel is considered as the high priority, the first channel is preferentially transmitted, the SL channel is not transmitted or is transmitted selectively later.

In some embodiments, the priority of the first channel is the second priority in the case that signaling indicates cancellation of uplink transmission. That is, in the case that the signaling indicates that the uplink transmission is canceled, the priority of the first channel is determined as the second priority (high priority), or a corresponding operation where the priority of the first channel is considered as the second priority (high priority) is performed. In some embodiments, performing the corresponding operation where the priority of the first channel is considered as the second priority (high priority) includes: not canceling the transmission of the first channel; and/or, canceling the transmission of a target channel, which does not carry information of the second priority. The above signaling may be DCI, e.g., DCI format 2_4 indicates cancellation of the uplink transmission. For example, the terminal device receives the DCI format 2_4 indicating that the uplink transmission is canceled, the terminal device does not cancel the transmission of the first channel and/or cancels the transmission of the target channel in the case that the first channel and the target channel (the target channel carries no information of the high priority) exist.

In some embodiments, in response to determining that the second information is transmitted over the first channel, the priority of the first channel is the second priority. That is, in response to determining that the second information is transmitted over the first channel, the priority of the first channel is determined as the second priority (high priority), or a corresponding operation where the priority of the first channel is considered as the second priority (high priority) is performed. For the first channel originally configured to transmit the first information of the low priority, in the case of determining that the second information of the high priority is multiplexed for transmission in the first channel, the priority of the first channel is considered as the second priority (high priority) in response to determining that the second information is transmitted over the first channel.

In some embodiments, the method according to the embodiments may be performed by a terminal device or performed by a network device.

In the technical solutions according to the embodiments of the present disclosure, in the case that the first channel having a predefined priority of the low priority carries the second information of the high priority, the priority of the first channel is considered as the high priority to ensure that there is no loss in the transmission performance of the second information of the high priority.

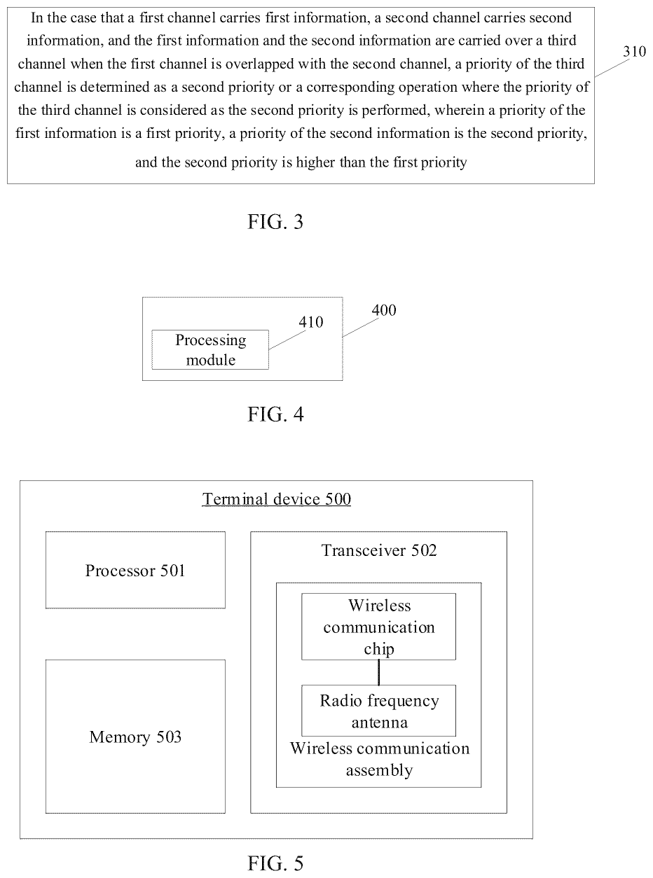

FIG. 3 is a flowchart of another method for wireless communication according to some embodiments of the present disclosure. Referring to FIG. 3, the method is applicable to the communication system shown in FIG. 1, and the method includes the following processes.

In process 310, in the case that a first channel carries first information, a second channel carries second information, and the first information and the second information are carried over a third channel when the first channel is overlapped with the second channel, a priority of the third channel is determined as a second priority or a corresponding operation where the priority of the third channel is considered as the second priority is performed. A priority of the first information is a first priority, a priority of the second information is the second priority, and the second priority is higher than the first priority.

In some embodiments, the physical channel may be configured with a 2-level priority, including a high priority and a low priority. The above second priority may also be referred to as the high priority and the first priority may also be referred to as the low priority. The priority value may be represented by a priority index, for example, the priority index corresponding to the second priority (high priority) is 1, i.e., the second priority (high priority) corresponds to priority index 1; and the priority index corresponding to the first priority (low priority) is 0, i.e., the first priority (low priority) corresponds to priority index 0. Certainly, it is only an example that the larger the priority index is, the higher the priority is. In some other possible implementations, it may also be specified that the smaller the priority index is, the higher the priority is, which is not limited in present disclosure.

In the embodiments of the present disclosure, the first channel is configured to carry the first information of the first priority, the second channel is configured to carry the second information of the second priority, and the second priority is higher than the first priority. That is, the first channel is configured to carry the first information of the low priority, the second channel is configured to carry the second information of the high priority, and the priority of the second information is higher than the priority of the first information, for example, the second information corresponds to priority index 1, and the first information corresponds to priority index 0. In the case that the first channel is overlapped with the second channel, the first information and the second information are carried over the third channel, and the priority of the third channel is the second priority (high priority). For example, the priority of the third channel is considered as the second priority, or the priority of the third channel is determined as the second priority, or the priority of the third channel is set as the second priority, or a corresponding operation where the priority of the third channel is considered as the second priority is performed.

In some embodiments, the first channel is overlapped with the second channel, which includes that the first channel is overlapped with the second channel in the time domain. For example, in the case that the first channel is overlapped with the second channel in the time domain, it may be considered that the first channel is overlapped with the second channel. In some embodiments, in the case that the first channel is overlapped with the second channel, the first channel and the second channel may also overlap in a frequency domain, in addition to that the first channel is overlapped with the second channelp in the time domain.

In some embodiments, the priority of the third channel is the second priority in the case of handling transmission power reduction. That is, in the case of handling transmission power reduction, the priority of the third channel is determined as the second priority (high priority), or a corresponding operation where the priority of the third channel is considered as the second priority is performed. For example, the transmission power of a channel of a low priority is preferentially reduced, and the transmission power of a channel of a high priority is not reduced or is reduced selectively later.

In some embodiments, the priority of the third channel is the second priority in the case of handling a collision with a SL channel. That is, in the case of handling a collision with a SL channel, the priority of the third channel is determined as the second priority (high priority), or a corresponding operation where the priority of the third channel is considered as the second priority is performed. In some embodiments, the SL channel is configured to transmit SL HARQ feedback information. For example, in the case that the third channel collides with the SL channel and the priority of the third channel is considered as the high priority, the third channel is preferentially transmitted, the SL channel is not transmitted or is transmitted selectively later.

In some embodiments, in response to determining that the first information and the second information are transmitted over the third channel, the priority of the third channel is the second priority. That is, in response to determining that the first information and the second information are transmitted over the third channel, the priority of the third channel is determined as the second priority, or a corresponding operation where the priority of the third channel is considered as the second priority is performed.

In some embodiments, the first channel and the second channel are both uplink channels, and accordingly, the third channel is also an uplink channel. In some embodiments, the third channel is a PUCCH. For example, the first channel and the second channel are both PUCCHs and the third channel is also a PUCCH.

In some embodiments, the third channel is preconfigured to transmit information of the the first priority or information of the second priority.

In some embodiments, the third channel is the first channel. For example, the first channel and the second channel are both PUCCHs, e.g., the first channel is a first PUCCH, the second channel is a second PUCCH, the first PUCCH and the second PUCCH are two different PUCCHs, and the third channel is the first PUCCH.

In some embodiments, the third channel is the second channel. For example, the first channel and the second channel are both PUCCHs, e.g., the first channel is a first PUCCH, the second channel is a second PUCCH, the first PUCCH and the second PUCCH are two different PUCCHs, and the third channel is the second PUCCH.

In some embodiments, the third channel is another channel different from the first channel and the second channel. For example, the first channel and the second channel are both PUCCHs, e.g., the first channel is a first PUCCH, the second channel is a second PUCCH, the first PUCCH and the second PUCCH are two different PUCCHs, and the third channel is a third PUCCH, which is another PUCCH different from the first PUCCH and the second PUCCH.

In some embodiments, the method according to the embodiments may be performed by a terminal device or performed by a network device.

In the technical solutions according to the embodiments of the present disclosure, when the first channel carrying information of the low priority and the channel carrying information of the high priority overlap, the information of the low priority and the information of the high priority is multiplexed for transmission in the same channel, and the channel configured to transmit the information of the low priority and the information of the high priority is considered as the high priority, thereby ensuring that there is no loss in the transmission performance of the information of the high priority.

In an exemplary embodiment, for example, the first channel is the first PUSCH and the second channel is the first PUCCH. The network device indicates the terminal device to transmit the first PUSCH, the first PUSCH may be a PUSCH dynamically scheduled by DCI or a PUSCH configured by higher layer signaling (PUSCH with configure grant), and the first PUSCH is of the low priority, which is indicated by the DCI, indicated by the higher layer signaling, or determined according to a protocol stipulation when no priority information is configured (i.e., defaulted as the low priority). The first PUSCH overlaps the first PUCCH, the first PUCCH is configured to carry the high-priority UCI (e.g., high-priority HARQ-ACK information), and the above high-priority UCI is multiplexed for transmission over the first PUSCH. In the case that the above conditions are satisfied:
(1) the priority of the first PUSCH is the high priority; or,
(2) in the case of handling transmission power reduction, the first PUSCH is processed according to the high priority; or,
(3) in the case of handling a collision between sidelink HARQ-ACK feedback and the PUSCH, the first PUSCH is processed according to the high priority; or,
(4) in the case that the terminal device receives the DCI format 2_4 indicating that the uplink transmission is canceled, the first PUSCH cannot be canceled, and/or the terminal device cancels the second PUSCH. The (preconfigured) priority of the second PUSCH is the low priority, and there is no multiplexing transmission of the high-priority UCI in the second PUSCH.

In this exemplary embodiment, when the PUSCH of the preconfigured low priority carries the high-priority UCI, the priority of the PUSCH is adjusted to ensure that there is no loss in the transmission performance of the high-priority UCI.

In an exemplary embodiment, description is given based on an example in which the first channel is the first PUCCH and the second channel is the second PUCCH. The first PUCCH is configured to carry the low-priority first UCI, the second PUCCH is configured to carry the high-priority second UCI, and the terminal device determines that the third PUCCH is configured to carry the first UCI and the second UCI in the case that the first and second PUCCHs overlap. In the case that the above conditions are satisfied:
(a) the priority of the third PUCCH is the high priority; or,
(b) in the case of handling of transmission power reduction, the third PUCCH is processed according to the high priority; or
(c) in the case of handling a collision between sidelink HARQ-ACK feedback and the PUCCH carrying downlink HARQ-ACK, the third PUCCH is processed according to the high priority.

In some embodiments, the third PUCCH is the first PUCCH, or the third PUCCH is the second PUCCH, or the third PUCCH is another PUCCH different from the first PUCCH and the second PUCCH.

In this exemplary embodiment, when the first PUCCH carrying the low-priority UCI overlaps the second PUCCH carrying the high-priority UCI, the low-priority UCI and the high-priority UCI is multiplexed for transmission in the same PUCCH. For example, the high-priority UCI is multiplexed for transmission in the first PUCCH, and the priority of the PUCCH configured to transmit the low-priority UCI and the high-priority UCI is considered as the high priority, thereby ensuring that there is no loss in the transmission performance of the high-priority UCI.

Based on the technical solutions of the present disclosure, revisions can be made to the current standard protocol, and several possible revisions are provided below.

Revision 1: it is applicable to ways (1) to (4) and (a) to (c) in the foregoing embodiments, but the following revisions to the standards are applicable to different sections. For example, the revisions in way (1)/(a) is applicable to all sections in the protocol; and the revisions in way (2)/(b) appears only in TS 38.213 section 7.5 Prioritizations for transmission power reductions.

The PUSCH or PUCCH for multiplexing HARQ-ACK information with priority index 1 is of priority index 1; or,
when a UE would multiplex HARQ-ACK information with priority index 1 in a PUSCH or PUCCH transmission, the PUSCH or PUCCH is of priority index 1.

Revision 2: it is applicable to way (3) in the foregoing embodiments.

When a UE determines overlapping for PUCCH transmissions with SL HARQ-ACK reports and PUSCH of larger priority index only or PUSCH with HARQ-ACK information with priority index 1, including repetitions if any, after resolving the overlapping PUCCH other than PUCCH transmissions with SL HARQ-ACK reports and/or PUSCH transmissions, the UE does not transmit the PUCCH with SL HARQ-ACK reports.

Revision 3: it is applicable to way (4) in the foregoing embodiments.

A UE that detects a DCI format 2_4 for a serving cell cancels a PUSCH transmission or an actual repetition of a PUSCH transmission [6, TS 38.214] if the PUSCH transmission is with repetition Type B, as determined in clauses 9 and 9.2.5 or in clause 6.1 of [6, TS 38.214], or an SRS transmission on the serving cell if, respectively,
the transmission is PUSCH with priority 0 without HARQ-ACK information with priority index 1, if the UE is provided uplinkCancellationPriority.

Revision 4: it is applicable to way (c) in the foregoing embodiments.

For prioritization between SL HARQ-ACK information in a first PUCCH and DL HARQ-ACK or SR or CSI in a second PUCCH:
if the second PUCCH has priority index 1 or the second PUCCH carrying HARQ-ACK information with priority index 1 as described in clause 9.2.5.3,
if sl-Priority Threshold-UL-URLLC is provided
   the UE transmits the first PUCCH if a smallest priority value of the first PUCCH is smaller than sl-PriorityThreshold-UL-URLLC; otherwise, the UE transmits the second PUCCH
else
   the UE transmits the second PUCCH
else
   the UE transmits the first PUCCH if the smallest priority value of the first PUCCH is smaller than sl-Priority Threshold; otherwise, the UE transmits the second PUCCH.

The following are apparatus embodiments of the present disclosure, which are capable of performing the method embodiments of the present disclosure. For details not disclosed in the apparatus embodiments of the present disclosure, reference may be made to the method embodiments of the present disclosure.

FIG. 4 is a block diagram of an apparatus for wireless communication according to some embodiments of the present disclosure. The apparatus has the function of implementing the above method embodiments, and the function may be achieved by hardware or by software executed by hardware. The apparatus may be a communication apparatus (e.g., a terminal device or a network device) or may be provided in a communication apparatus. As shown in FIG. 4, the apparatus 400 includes a processing module 410.

The processing module 410 is configured to: in a case that a first channel carries first information and second information, determine a priority of the first channel as a second priority or perform a corresponding operation where the priority of the first channel is considered as the second priority, wherein a priority of the first information is a first priority, a priority of the second information is the second priority, and a predefined priority of the first channel is the first priority, wherein the first channel is overlapped with a second channel configured to transmit the second information, and the second priority is higher than the first priority.

In some embodiments, the predefined priority of the first channel being the first priority includes the following scenario:
the first channel is configured to transmit the first information; or
configuration information indicates that the predefined priority of the first channel is the first priority; or
a protocol stipulates that the predefined priority of the first channel is the first priority.

In some embodiments, the second channel is not transmitted.

In some embodiments, the first channel being overlapped with the second channel includes a scenario where the first channel is overlapped with the second channel in time domain.

In some embodiments, the first channel carrying the first information and the second information includes:
the first information is transmitted over the first channel upon being processed based on a configuration parameter of the first priority; and/or,
the second information is transmitted over the first channel upon being processed based on a configuration parameter of the second priority.

In some embodiments, the processing includes at least one of: encoding, rate matching, or resource mapping.

In some embodiments, the processing module 410 is configured to: in a case of handling transmission power reduction, determine the priority of the first channel as the second priority or perform the corresponding operation where the priority of the first channel is considered as the second priority.

In some embodiments, the processing module 410 is configured to: in a case of handling a collision with a SL channel, determine the priority of the first channel as the second priority or perform the corresponding operation where the priority of the first channel is considered as the second priority.

In some embodiments, the SL channel is configured to transmit SL HARQ feedback information.

In some embodiments, the processing module 410 is configured to: in a case that signaling indicates cancellation of uplink transmission, determine the priority of the first channel as the second priority or perform the corresponding operation where the priority of the first channel is considered as the second priority.

In some embodiments, the processing module 410 is further configured to: not cancel transmission of the first channel; and/or cancel transmission of a target channel, wherein the target channel does not carry information of the second priority.

In some embodiments, the configuration information is higher layer signaling or DCI.

In some embodiments, the processing module 410 is configured to: in response to determining that the second information is transmitted over the first channel, determine the priority of the first channel as the second priority, or perform the corresponding operation where the priority of the first channel is considered as the second priority.

In some embodiments, the first channel is a PUSCH or a PUCCH.

In some embodiments, the apparatus is provided in a terminal device or a network device.

Still referring to FIG. 4, in another exemplary embodiment of the present disclosure, the processing module 410 is configured to: in a case that the first channel carries the first information, the second channel carries the second information, and the first information and the second information are carried over a third channel when the first channel is overlapped with the second channel, determine a priority of the third channel as a second priority or perform a corresponding operation where the priority of the third channel is considered as the second priority, wherein the priority of the first information is the first priority, and the priority of the second information is the second priority, wherein the second priority is higher than the first priority.

In some embodiments, the processing module 410 is configured to: in a case of handling transmission power reduction, determine the priority of the third channel as the second priority or perform the corresponding operation where the priority of the third channel is considered as the second priority.

In some embodiments, the processing module 410 is configured to: in a case of handling a collision with a SL channel, determine the priority of the third channel as the second priority or perform the corresponding operation where the priority of the third channel is considered as the second priority.

In some embodiments, the SL channel is configured to transmit SL HARQ feedback information.

In some embodiments, the apparatus is provided in a terminal device or a network device.

In some embodiments, the processing module 410 is configured to: in response to determining that the first information and the second information are transmitted over the third channel, determine the priority of the third channel as the second priority, or perform the corresponding operation where the priority of the third channel is considered as the second priority. In some embodiments, the third channel is a PUCCH.

In some embodiments, the third channel is preconfigured to transmit information of the first priority or information of the second priority.

In some embodiments, the third channel is the first channel.

It should be noted that the division of the above-described functional modules is only an example for illustration when the apparatus according to the foregoing embodiments implements its functions, and in practice, the above-described functions can be assigned to be completed by different functional modules according to actual needs, that is, the structure of the apparatus can be divided into different functional modules to complete all or part of the above-described functions.

With respect to the apparatus in the foregoing embodiments, the specific manner in which each module performs an operation has been described in detail in the method embodiments, and will not be described in detail herein.

FIG. 5 is a schematic structural diagram of a terminal device 500 according to some embodiments of the present disclosure. The terminal device 500 can be used to perform the above method for wireless communication. The terminal device 500 includes a processor 501, a transceiver 502, and a memory 503.

The processor 501 includes one or more processing cores, and runs various functional applications and performs information processing by running software programs and modules.

The transceiver 502 includes a receiver and a transmitter. For example, the receiver and a transmitter are practiced as a single wireless communication assembly, and the wireless communication assembly includes one wireless communication chip and a radio frequency antenna.

The memory 503 is connected to the processor 501 and the transceiver 502.

The memory 503 is configured to store one or more computer programs, and the processor 501, when loading and running the one or more computer programs, is caused to perform the processes performed by the terminal device in the foregoing method embodiments.

In addition, the memory 503 is implemented by any type of volatile or non-volatile storage device or combinations thereof. The volatile or non-volatile storage device includes, but is not limited to: a disk or an optical disc, an electrically-erasable programmable read-only memory, an erasable programmable read-only memory, a static random access memory, a read-only memory (ROM), a magnetic memory, a flash memory, or a programmable read-only memory.

In some embodiments, the processor 501 is configured to, in a case that a first channel carries first information and second information, determine a priority of the first channel as a second priority or perform a corresponding operation where the priority of the first channel is considered as the second priority, wherein a priority of the first information is a first priority, a priority of the second information is the second priority, and a predefined priority of the first channel is the first priority, wherein the first channel is overlapped with a second channel configured to transmit the second information, and the second priority is higher than the first priority.

In some embodiments, the processor 501 is configured to, in a case that a first channel carries first information, a second channel carries second information, and the first information and the second information are carried over a third channel when the first channel is overlapped with the second channel, determine a priority of the third channel as a second priority or perform a corresponding operation where the priority of the third channel is considered as the second priority, wherein a priority of the first information is a first priority, and a priority of the second information is the second priority, wherein the second priority is higher than the first priority.

For details not described in detail in the foregoing embodiments, reference may be made to the descriptions in the foregoing method embodiments, and details will not be repeated herein.

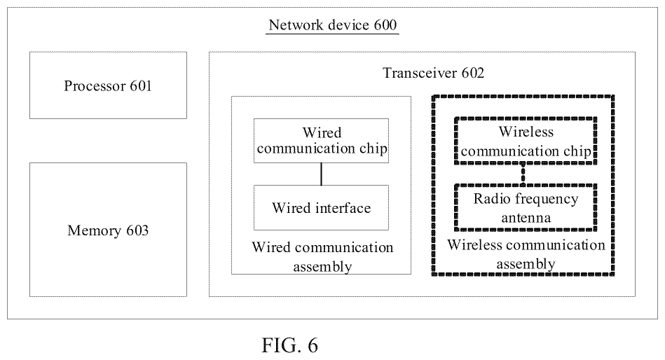

FIG. 6 is a schematic structural diagram of a network device 600 according to some embodiments of the present disclosure. The network device 600 can be used to perform the above method for wireless communication. The network device 600 includes a processor 601, a transceiver 602, and a memory 603.

The processor 601 includes one or more processing cores, and runs various functional applications and performs information processing by running software programs and modules.

The transceiver 602 includes a receiver and a transmitter. For example, the transceiver 602 includes a wired communication assembly, and the wired communication assembly includes one wired communication chip and a wired interface (for example, a fiber interface). In some embodiments, the transceiver 602 includes a wireless communication assembly, and the wireless communication assembly includes one wireless communication chip and a radio frequency antenna.

The memory 603 is connected to the processor 601 and the transceiver 602.

The memory 603 is configured to store one or more computer programs, and the processor 601, when loading and running the one or more computer programs, is caused to perform the processes performed by the network device in the foregoing method embodiments.

In addition, the memory 603 is implemented by any type of volatile or non-volatile storage device or combinations thereof. The volatile or non-volatile storage device includes, but is not limited to: a disk or an optical disc, an electrically-erasable programmable read-only memory, an erasable programmable read-only memory, a static random access memory, a read-only memory, a magnetic memory, a flash memory, or a programmable read-only memory.

In some embodiments, the processor 501 is configured to, in a case that a first channel carries first information and second information, determine a priority of the first channel as a second priority or perform a corresponding operation where the priority of the first channel is considered as the second priority, wherein a priority of the first information is a first priority, a priority of the second information is the second priority, and a predefined priority of the first channel is the first priority, wherein the first channel is overlapped with a second channel configured to transmit the second information, and the second priority is higher than the first priority.

In some embodiments, the processor 501 is configured to, in a case that a first channel carries first information, a second channel carries second information, and the first information and the second information are carried over a third channel when the first channel is overlapped with the second channel, determine a priority of the third channel as a second priority or perform a corresponding operation where the priority of the third channel is considered as the second priority, wherein a priority of the first information is a first priority, and a priority of the second information is the second priority, wherein the second priority is higher than the first priority.

For details not described in detail in the foregoing embodiments, reference may be made to the descriptions in the foregoing method embodiments, and details will not be repeated herein.

The embodiments of the present disclosure further provide a communication device, and the communication device includes a processor and a memory. The memory stores one or more computer programs, and the processor, when loading and running the one or more computer programs, is caused to perform the method for wireless communication. In some embodiments, the communication device may be a terminal device or a network device.

The embodiments of the present disclosure further provide a computer-readable storage medium, and the storage medium stores one or more computer programs therein. The one or more computer programs, when loaded and run by a processor of a communication device, cause the communication device to perform the method for wireless communication.

In some embodiments, the computer-readable storage medium includes: a ROM, a random-access memory (RAM), a solid state drive (SSD), an optical disc, or the like. The RAM includes a resistance random access memory (ReRAM) and a dynamic random access memory (DRAM).

The embodiments of the present disclosure further provide a chip. The chip includes a programmable logic circuitry and/or one or more program instructions, and the chip, when running on a communication device, causes the communication device to perform the above method for wireless communication.

The embodiments of the present disclosure further provide a computer program product or a computer program including one or more computer instructions therein. The one or more computer instructions are stored in a computer-readable storage medium. The one or more computer instructions, when read from the computer-readable storage medium and executed by a processor of a communication device, cause the communication device to perform the above method for wireless communication.

It should be understood that the term “a plurality of” herein means two or more. The term “and/or” herein describes an association relationship between associated objects, and indicates three types of relationships. For example, the phrase “A and/or B” means (A), (B), or (A and B). The character “/” generally represents an “or” relationship between the associated objects.

In addition, the serial number of the processes described herein only illustrates a possible sequence of performing the processes. In some other embodiments, the above processes may be not performed according to the above sequence, for example, two processes numbered differently are performed simultaneously or performed in an order opposite to that shown in the drawings, which is not limited in the embodiments of the present disclosure.

Those skilled in the art should understand that in the foregoing one or more embodiments, the functions described in the embodiments of the present disclosure are implemented by hardware, software, firmware or any combinations thereof. In the case that the functions are implemented by software, the functions are stored in a computer-readable storage medium or are transmitted as one or more instructions or codes in the computer-readable storage medium. The computer-readable storage medium includes a computer storage medium and a communication medium, and the communication medium includes any medium facilitating transmission of computer programs from one place to another place. The storage medium is any available medium accessible by a general or specific computer.

Described above are merely exemplary embodiments of the present disclosure, and are not intended to limit the present disclosure. Any modifications, equivalent substitutions, improvements, and the like, made within the spirit and principles of the present disclosure should fall within the scope of protection of the present disclosure.

1. A method for wireless communication, comprising:
in a case that a first channel carries first information and second information, determining a priority of the first channel as a second priority or performing a corresponding operation where a priority of the first channel is considered as a second priority, wherein a priority of the first information is a first priority, a priority of the second information is the second priority, and a predefined priority of the first channel is the first priority, wherein the first channel is overlapped with a second channel configured to transmit the second information, and the second priority is higher than the first priority.

2. The method according to claim 1, wherein the predefined priority of the first channel being the first priority comprises one of the following scenarios:
the first channel is configured to transmit the first information;
configuration information indicates that the predefined priority of the first channel is the first priority; and
a protocol stipulates that the predefined priority of the first channel is the first priority.

3. The method according to claim 1, wherein the first channel carrying the first information and the second information comprises at least one of following scenarios:
the first information is transmitted over the first channel upon being processed based on a configuration parameter of the first priority; and
the second information is transmitted over the first channel upon being processed based on a configuration parameter of the second priority.

4. The method according to claim 3, wherein the processing comprises at least one of:
encoding, rate matching, or resource mapping.

5. The method according to claim 1, wherein determining the priority of the first channel as the second priority or performing the corresponding operation where the priority of the first channel is considered as the second priority comprises:
in a case of handling transmission power reduction, determining the priority of the first channel as the second priority or performing the corresponding operation where the priority of the first channel is considered as the second priority.

6. The method according to claim 1, wherein determining the priority of the first channel as the second priority or performing the corresponding operation where the priority of the first channel is considered as the second priority comprises:
in a case of handling a collision with a sidelink (SL) channel, determining the priority of the first channel as the second priority or performing the corresponding operation where the priority of the first channel is considered as the second priority.

7. The method according to claim 6, wherein the SL channel is configured to transmit SL hybrid automatic repeat request (HARQ) feedback information.

8. The method according to claim 1, wherein determining the priority of the first channel as the second priority or performing the corresponding operation where the priority of the first channel is considered as the second priority comprises:
in a case that signaling indicates cancellation of uplink transmission, determining the priority of the first channel as the second priority or performing the corresponding operation where the priority of the first channel considered as the second priority.

9. The method according to claim 8, wherein the corresponding operation where the priority of the first channel is considered as the second priority comprises at least one of:
not cancelling transmission of the first channel; or
canceling transmission of a target channel, wherein the target channel does not carry information of the second priority.

10. The method according to claim 1, wherein the first channel is a physical uplink shared channel (PUSCH) or a physical uplink control channel (PUCCH).

11. A communication device, comprising:
a processor and a memory storing at least one computer program, which when executed by the processor, causes the communication device to:
in a case that a first channel carries first information and second information, determine a priority of the first channel as a second priority or performing a corresponding operation where a priority of the first channel is considered as a second priority, wherein a priority of the first information is a first priority, a priority of the second information is the second priority, and a predefined priority of the first channel is the first priority, wherein the first channel is overlapped with a second channel configured to transmit the second information, and the second priority is higher than the first priority.

12. The communication device according to claim 11, wherein the predefined priority of the first channel being the first priority comprises one the following scenarios:
the first channel is configured to transmit the first information;
configuration information indicates that the predefined priority of the first channel is the first priority; and
a protocol stipulates that the predefined priority of the first channel is the first priority.

13. The communication device according to claim 11, wherein the first channel carrying the first information and the second information comprises at least one of following scenarios:
the first information is transmitted over the first channel upon being processed based on a configuration parameter of the first priority; and
the second information is transmitted over the first channel upon being processed based on a configuration parameter of the second priority.

14. The communication device according to claim 13, wherein the processing comprises at least one of: encoding, rate matching, or resource mapping.

15. The communication device according to claim 11, wherein the processor, when loading and running the at least one computer program, causes the communication device to perform:
in a case of handling transmission power reduction, determining the priority of the first channel as the second priority or performing the corresponding operation where the priority of the first channel is considered as the second priority.

16. The communication device according to claim 11, wherein the processor, when loading and running the at least one computer program, causes the communication device to perform:
in a case of handling a collision with a sidelink (SL) channel, determining the priority of the first channel as the second priority or performing the corresponding operation where the priority of the first channel is considered as the second priority.

17. The communication device according to claim 16, wherein the SL channel is configured to transmit SL hybrid automatic repeat request (HARQ) feedback information.

18. The communication device according to claim 11, wherein the processor, when loading and running the at least one computer program, causes the communication device to perform:
in a case that signaling indicates cancellation of uplink transmission, determining the priority of the first channel as the second priority or performing the corresponding operation where the priority of the first channel considered as the second priority.

19. The communication device according to claim 18, wherein the corresponding operation where the priority of the first channel is considered as the second priority comprises at least one of:
not cancelling transmission of the first channel; or
canceling transmission of a target channel, wherein the target channel does not carry information of the second priority.

20. The communication device according to claim 11, wherein the first channel is a physical uplink shared channel (PUSCH) or a physical uplink control channel (PUCCH).
